(19) United States
(12) Patent Application Publication
(10) Pub. No.: US 2006/0284424 A1
(43) Pub. Date: Dec. 21, 2006

(54) Tilt latch

(76) Inventors: Peter Newbould, Milano (IT); Sigurdur Thorsteinsson, Milano (IT); Mauro Porcini, Milano (IT)

Correspondence Address: Attn: Thomas A. O'Rourke;Bodner & O'Rourke, 425 Broadhollow Road, Melville, NY, 11747, US

(21) Appl. No.: 11/157,146

(22) Filed: Jun. 20, 2005

(51) Int. Cl. E05C 1/10

(52) U.S. Cl. 292/175

(57) ABSTRACT

A tilt latch for a window having a housing with a top plate and a base member. The top plate has an upper surface and a bottom surface and one or more sidewalls extending downwardly from the bottom surface of the top plate. The top plate has a first front recessed portion and a second front recessed portion, as well as a first rear recessed portion and a second rear recessed portion. The first front recessed portion and second front recessed portion are separated from each other by a front tongue member. The first rear recessed portion and second rear recessed portion are separated by a rear tongue member. The tongue member allows the top plate to lock to the base member.

### FIELD OF THE INVENTION

The present invention is directed to window hardware and in particular improved tilt latches for double hung windows and the like.

### BACKGROUND OF THE INVENTION

One of the common window types in widespread use today is double hung windows. These windows typically have a top sash and a bottom sash. The sashes usually move in a vertical direction in opening and closing the windows. The lower sash is opened to permit cool air to enter a room and the top sash may be lowered to allow hotter air to escape from the room.

The sashes in double hung windows have a frame, usually with a horizontal top member and a horizontal bottom member and a pair of opposing vertical side members connecting the top and bottom members. The members are joined together generally to form a rectangular or square frame which contains one or more panes of glass.

Many older houses have double hung windows that are not as weather tight as current windows. The weather stripping may have deteriorated, or there may be rot or cracks in the frame or glass. Accordingly, there is a great deal of interest among consumers in replacing older double hung windows, or at least replacing one or both of the sashes with a newer version. In addition to replacement windows, many double hung windows are used in new construction because the public desires the look of these windows. For example, double hung windows with a plurality of glass lites such as six, nine or twelve lites separated by muntin bars provide a “colonial” look to the windows that is highly desirable for many homeowners. Accordingly, there is a significant market for double hung windows.

One feature that older double hung windows lack that newer windows have is a sash tilt feature. This feature is highly desirable and provides a great deal of incentive to the consumer for replacing the old windows. Traditional double hung windows only moved up or down and this made it fairly difficult to clean the outside of the windows particularly where the windows were on a second floor or other difficult to reach location. In many instances cleaning the windows required the use of a ladder which always raises safety issues. More recent double hung windows have a tilt feature that enables the homeowner to tilt the sash inwardly for cleaning. In view of the convenience offered by the tilt feature, many homeowners have elected to replace the older non-tilting windows with the current tilting double hung windows. The tilt feature is not limited to double hung windows but can include transom and other single sash or multiple sash windows.

Many of the current tilting sashes employ the use of a pair of tilt latches on the upper surface of the top member. The tilt latches are positioned at opposite ends of the top member of each sash. These tilt latches permit the sash to be raised and lowered to a desired position for ventilation, for example, and retained there. The tilt latch has a retractable spring loaded tongue that may pass through an opening in the side wall of the window frame to retain the sash in a desired position. Tilt latches are known in the art.

Tilt latches are used adapted for releasably securing a pivotable or tilting sash window to a master frame. One type of such latch is shown in U.S. Pat. No. 4,578,903. This patent is for a generally flush mounted pivotable latch. Another tilt latch is shown in U.S. Pat. No. 5,139,291. In this patent, the sash latch has a housing with a cover and a pair of side walls extending from the cover. Each of the side walls has a side wall rail and a longitudinal groove between the cover and the side wall rail that receives a pair of header rails in the top sash rail.

Another tilt latch is the type that has been sold by Ro Mai Industries of Twinsburg, Ohio. In the Ro Mai tilt latch, there is a housing having a cover and a pair of side walls extending from the underside of the cover. The Ro Mai device further has a pair of bosses in the sidewall that permit the sash latch to be snapped in the top sash.

Still another tilt latch is sold by Truth. This latch has a housing with a cover and a side wall extending from the underside of the cover. There is a base section that also has a side wall extending upwardly. The width of the base side wall is larger than the sidewall of the housing. The top surface of the base side wall and the underside of the cover form a recess around the perimeter of the latch.

Silverline also offers a latch having a housing with a cover. Extending from the underside of the cover is a side wall. On the underside of the housing is a base that has three members extending upwardly from the top surface of the base. The extending members provide a glue surface to adhere the base to the sidewalls of the housing.

In U.S. Pat. No. 6,178,696 there is described a construction of a sash latch that uses reduced amounts of raw materials in the construction thereof while retaining the strength of the product.

### OBJECTS OF THE INVENTION

It is an object of the present invention to provide an improved tilt latch that has a casing that is less likely to come apart than traditional tilt latches.

It is another object of the invention to provide a tilt latch that is simple to assemble.

It is a further object of the invention to provide a tilt latch that has a minimum number of parts.

It is a still further object of the invention to provide an improved tilt latch that need not be assembled using adhesives.

It is another object of the invention to provide a tilt latch that will not permit the spring and the bolt to become separated from the assembled latch.

### SUMMARY OF THE INVENTION

The present invention is directed to a tilt latch for double hung or other windows that may be tilted. The present tilt latch allows the user to slide and lock the window sash in place within the window channel.

The tilt latch may comprise a housing which may attach to a base member. The housing may be equipped with a series of attachment legs that provide a locking fit with the base member. The housing may have an opening in which a latch may reside. The latch may be adapted to slide in a single plane. The movement of the latch can control the extension of the depending key into the window channel. The depending key creates a pressurized fit between the window sash and the window channel. Thus, a homeowner can compress the latch, thereby disengaging the depending key from the window channel. The window sash may move freely within the channel, while the latch is compressed. When the user wishes to lock the sash in a particular spot within the window channel, the latch may be released. The spring which attaches to the latch will press the depending key into the window channel.

A significant feature of the present tilt latch is the snap-fit provided by the attachment legs on the housing. The base member can be adapted to receive the attachment legs. When assembled, the housing and base member provide a channel for the movement of the latch. The end of the latch opposite the depending key is attached to a spring. In an equilibrium position, the depending key may protrude from the channel provided by the housing and base member. In a compressed position, the depending key may recede into the channel and become flush with the edges of the housing and base member.

### BRIEF DESCRIPTION OF THE DRAWINGS

FIG. 1 is a bottom view of the housing of the present invention.

FIG. 2 is a cutaway view of the housing of FIG. 1 taken along A-A.

FIG. 2A is a view of the housing of FIG. 1 taken along B-B

FIG. 3 is a side view of the housing of FIG. 1.

FIG. 4 is a perspective view of the housing of FIG. 1.

FIG. 5 is a top view of the base member of the present invention.

FIG. 6 is a bottom view of the base member of FIG. 5.

FIG. 6A is a cutaway view of the base member of FIG. 6 taken along B-B

FIG. 7 is a cutaway view of the base member of FIG. 5 taken along A-A.

FIG. 8 is a perspective view of the base member of FIG. 5.

FIG. 9 is a perspective view of the latch of the present invention.

FIG. 10 is a perspective view of a second embodiment of the present invention with a square end housing.

FIG. 11 is a perspective view of a second embodiment of the present invention with a rounded end housing.

FIG. 12 is a top view of the tilt latch of FIG. 10.

### DETAILED DESCRIPTION OF THE INVENTION

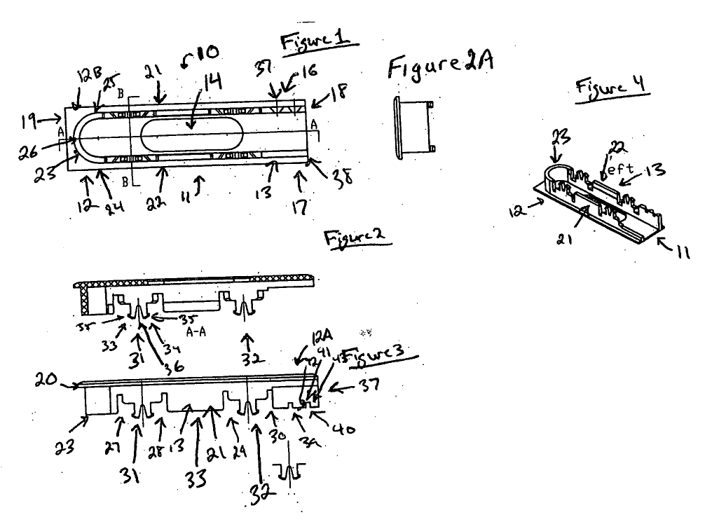

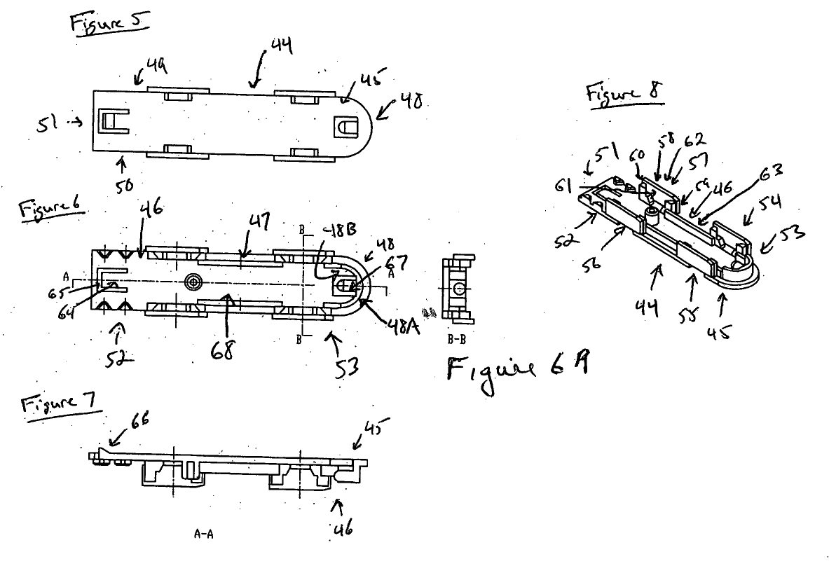

The pivot latch of the present invention 10 has a housing 11 with a top plate 12 and at least one downwardly extending side wall 13, which can be seen clearly in FIGS. 1-4. The top plate may have a top or upper surface 12A and a bottom surface 12B. There are one or more sidewalls that extend downwardly from the bottom surface 12B of the top plate. An opening 14 may be present in the upper surface 12A of the top plate 12. This opening can be for a means to engage and disengage a latch. The top plate 12 is preferably generally rectangular in configuration and has a first side edge 16 and a second side edge 17, as well as first end edge 18 and a second end edge 19. Customers typically prefer to have a pivot latch in their windows that has an upper surface 12A that is as close as possible to being flush with the surface of the top sash as possible, which gives the window sash a smooth look. However, the present device may be modular, such that it may be interchanged between a series of sashes, for both top and bottom sashes. Accordingly, the top plate preferably is provided with a champfered edge 20 around its perimeter to create the impression of a relatively flush top surface.

In a preferred embodiment, the sidewall 13 that extends from the bottom surface 12B of the top plate 12 has a first sidewall surface 21 and a second sidewall surface 22. The first sidewall surface 21 and second sidewall surface 22 may be joined by a third sidewall surface 23. In one embodiment, the third sidewall surface 23 may be curved or have a generally horseshoe-shaped configuration. Alternatively, the third sidewall surface 23 may be generally perpendicular to each of the other side wall surfaces, forming right angles with the first sidewall surface 21 and second sidewall surface 22.

As seen in FIGS. 1-4, the third sidewall surface 23 is shown as having a generally U-shaped configuration with a first leg 24, a second leg 25 and curved base section 26 connecting the two legs. Although the third sidewall surface 23 is depicted as having a curved base section with straight legs, there can be different combinations of straight and curved portions as desired. Similarly, although the third sidewall surface has been depicted as generally a single unitary member it will be appreciated that the legs and the base section may be discontinuous with respect to each other as well.

As seen in FIG. 3, on the first sidewall surface 21, there may be first front recessed portion 27 and a second front recessed portion 28, as well as a first rear recessed portion 29 and a second rear recessed portion 30. The first front recessed portion and second front recessed portion may be separated from each other by a front tongue member 31. The first rear recessed portion 29 and second rear recessed portion 30 may be separated by a rear tongue member 32. The second front recessed portion 28 and the first rear recessed portion can be separated by a sidewall 33.

Front tongue member 31 and rear tongue member 32 are seen clearly in FIG. 2. Preferably, the entire housing 11 is symmetrical about a longitudinal axis, and thus, each tongue may be identically manufactured and described. Tongue member 31 may be composed of a first leg 33 and a second leg 34. Each leg may be equipped with a flange 35, which will allow the housing 11 to lock to a base member. It is understood that the pair of legs shown may be replaced with a solitary leg, or a plurality of legs, as is desired. Preferably, the legs are separated by a compressive space 36. Thus, when the base member is pressed over the legs of the housing 11, the legs 11 may bend inwardly towards each other, allowing the base member to fit in place. When the base member has been depressed passed the flanges of each leg, the legs will return to their rest positions, and the flanges will be locking the base member in place.

The recessed portions 29 and 30 are preferably generally rectangular and have a top edge, a bottom edge and two opposed side edges. It is preferred that the recessed portions extend through the sidewalls of the housing. Additionally, first endwall 37 and second endwall 38, each are provided with a first orifice 39 and a second orifice 40. Each of the orifices preferably have a base edge 41 and side edges 42 and 43. The first and second orifices are preferably generally rectangular in shape.

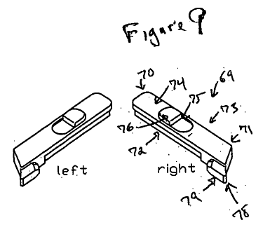

In addition to the housing, there may be a base member 44, which is seen clearly in FIGS. 5-8. Base member 44 may be securable to the housing. The base member 44 may have a top surface 45 and a bottom surface 46. The top and bottom surfaces can be joined by a side edge 47. The base member may have a configuration wherein there is a curved rear sidewall 48 and a pair of opposing generally straight side edges 49 and 50. Opposite the curved edge can be a generally straight front edge 51 that is generally perpendicular to each of side edges 49 and 50. The bottom surface 46 of the base member 44 may have a front portion 52 and a rear portion 53.

The bottom surface 46 of the base member 44 may be generally provided with a plurality of upwardly extending members 54, 55, 56 and 57. Each extending member may have a top edge 58, and a pair of side edges 59 and 60. In addition, each extending member may have an inner face 61 and an outer face 62. Adhered to the outer face 62 of each extending member may be a tab support 63. The tab support can extend from one extending member to a second adjacent extending member, which may be in the same plane as the first extending member. For example, in FIG. 8, tab support 63 extends from extending member 57 to extending member 54.

On the top surface 45 of the base member 44 may be a retaining means 64 that fills a slot 65. The retaining means 64 may be in the form of a tab, which has a raised surface 66 which can extend inwardly into the window channel, providing additional means to hold the window sash in place.

At the rear of the base member 44, there may be a curved sidewall 48 that extends upwardly from the bottom surface 46 of the base member 44. The curved sidewall 48 may have an exterior surface 48A and an interior surface 48B. The exterior surface 48A is preferably recessed from the rear curved sidewall 48 of the base member 44. This permits the curved sidewall 26 of the housing 11 to align with the curved sidewall 48 of the base member 44.

Extending inwardly from the curved interior surface 48B may be a pin 67. The pin 67 can act as a support for a spring (not shown). The spring can attach to a surface of the latch that will reside within the channel 68 created by the attachment of the housing 11 to the base member 44.

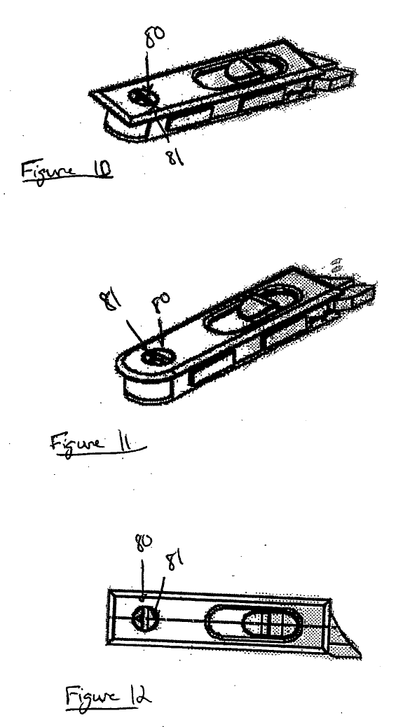

The latch 69 of the present invention can be seen clearly in FIG. 10. The latch may be generally rectangular shaped with a top surface 70, a bottom surface 71 and two side surfaces 72 and 73. Top surface 70 may be adapted with a means to retain the spring previously referred to. An outer surface 74 of the latch 69 may be equipped with a fingerhold means 75. Preferably, fingerhold means 75 will have a recessed portion 76 and a raised portion 77. The user may put his or her finger in the recessed portion and apply pressure in the direction of the raised portion. Some force may need to be applied, because the movement described will compress the spring.

On the bottom surface 71 of the latch 69, there may be a depending key 78. The depending key 78 helps to retain the pivot latch in position in a window channel when the spring is not compressed. The depending key 78 may generally protrude from the channel 68 created by the housing 11 and base member 44. The channel may have generally four edges and be in the form of a square or rectangle. The depending key 78 may take the form of a triangular member, as seen in FIG. 10. The depending key 78 preferably has a downwardly protruding tip 79 that extends from the channel 68. This tip 79 may contacts the inner surface of the window channel and prevent the pivot latch from slipping outwardly from the frame.

In assembling the pivot latch of the present invention, the latch 69 may be placed on the base member 44 with an end of the spring (not shown) over the pin 67 and the other end of the spring (not shown) in contact with the top surface 70 of the latch 69. The housing 11 may be placed over the base member 44, and the two can create a snap-fit, such that the flanges 35 will rest on the top surface 45 of the base member 44.

As seen in FIGS. 10-12, another embodiment of the present invention may incorporate a locking means such as a screw 80 rotatably mounted in the upper surface 12A of top plate 12. Locking screw 80 can have a face 81 that can be adapted to fit a Torx, Philips- or Flat-head screwdriver or other types of drivers. The locking means is generally cylindrical and having a top face and a bottom face. On a side opposite face 81 can be a tab or retaining wall on a portion of the bottom surface of the locking means. The tab when placed in a locking position can engage the coils of the spring so that the latch cannot be released. When placed in an unlocked position the latch 69 can be slid back from its equilibrium position, thus releasing the window sash. When the latch 69 is in a desired position, a user can turn the locking screw 80. When the locking screw 80 is turned, it can hold the spring (not shown) in position. In this position, the depending key 78 may be retained in position within the channel 68.

We claim:

1. A tilt latch for a window comprising a housing having top plate and a base member, said top plate having an upper surface and a bottom surface and one or more sidewalls extending downwardly from the bottom surface of the top plate, said top plate having an opening said opening having a means therein for engaging and disengaging a latch, said top plate having a first front recessed portion and a second front recessed portion, as well as a first rear recessed portion and a second rear recessed portion, said first front recessed portion and second front recessed portion being separated from each other by a front tongue member, said first rear recessed portion and second rear recessed portion being separated by a rear tongue member, said tongue member being composed of at least one leg having a flange which will allow the top plate to lock to said base member, said base member having a top surface and a bottom surface, said top surface of the base member having a retaining means, said retaining means being in the form of a tab, which has a raised surface, said latch further comprising a locking means for locking the spring in a locked position.

2. The tilt latch according to claim 1 wherein said locking means comprises a member having a tab extending therefrom said tab blocking the movement of said spring when said locking means is in a first position and said tab releasing said tab when moved to a second position.

3. The tilt latch according to claim 2 wherein at the rear of the base member there is a curved sidewall that extends upwardly from the bottom surface 46 of the base member, said curved sidewall having an exterior surface and an interior surface, the exterior surface being recessed from a rear curved sidewall of the base member, said curved sidewall of the housing aligning with the curved sidewall of the base member.

4. The tilt latch according to claim 3 wherein there is a pin extending inwardly from the curved interior surface of said sidewall, said pin acting as a support for a spring.

5. The tilt latch according to claim 4 wherein said bottom surface of the base member has a plurality of upwardly extending members, each extending member may have a top edge and a pair of side edges, each extending member also having an inner face and an outer face, said outer face of each extending member having a tab support, said tab support extending from one extending member to a second adjacent extending member.

6. The tilt latch according to claim 5 wherein there is a latch that is generally rectangular shaped with a top surface, a bottom surface and two side surfaces, said top surface having a means to retain the spring in position in said tilt latch, an outer surface of the latch being provided with a fingerhold means.

7. The tilt latch according to claim 6 wherein said fingerhold means has have a recessed portion and a raised portion.

8. The tilt latch according to claim 1 wherein said top plate locks to said base when said base member is pressed over said leg of the housing and past said flange of said leg.

9. The tilt latch according to claim 1 wherein the bottom surface of the base member is provided with a plurality of extending members said extending members having an outer face and an inner face, said inner and outer face having a recessed portion engaging said tongue member of the housing and retaining said flanges on said tongue.

10. The tilt latch according to claim 1 wherein said locking means comprises a member having a tab extending from said locking means blocking the movement of said spring when said locking means is in a first position and said tab releasing said tab when moved to a second position.

11. The tilt latch according to claim 4 wherein said bottom surface of the base member has a plurality of upwardly extending members, each extending member may have a top edge and a pair of side edges, each extending member also having an inner face and an outer face, said inner face of each extending member having a recessed portion providing a snap-fit for said tongue member of the housing and retaining said flanges of the tongue, said outer face of each extending member having a tab support, said tab support extending from one extending member to a second adjacent extending member.
